(19) United States
(12) Patent Application Publication
(10) Pub. No.: US 2002/0016746 A1
(43) Pub. Date: Feb. 7, 2002

(54) Customized motor oil selection

(76) Inventors: Michael E. McHenry, Washington, NJ (US); Irwin L. Goldblatt, Edison, NJ (US); Charles S. Seymour, Milford, NJ (US); Myron G. Brown, Flemington, NJ (US); Anthony D. Smith, Flemington, NJ (US)

Correspondence Address: NIXON & VANDERHYE P.C., 8th Floor, 1100 North Glebe Road, Arlington, VA, 22201, US

(21) Appl. No.: 09/829,393

(22) Filed: Apr. 10, 2001

Related U.S. Application Data
(60) Provisional application No. 60/196,294, filed on Apr. 12, 2000.

(51) Int. Cl. G06F 17/60

(52) U.S. Cl. 705/26; 705/1

(57) ABSTRACT

Vehicle owners or other users may obtain a motor vehicle engine oil having user desired enhancements, by using a wide area computer network, such as the Internet. In a preferred embodiment an electronic questionnaire is displayed on the user's computer screen, and the user answers inquiries about the environment of the use and desired operational characteristics of the desired oil, as well as information about the vehicle, ambient temperature, average driving distance, normal type of driving, and customer interest in fuel economy, cold weather starting, engine longevity and extended oil drain intervals and also to provide a centralized facility with information sufficient to determine what standard or customized motor oil would be most suitable for the user. A customized motor oil may be produced having a baseline motor oil from about 50 percent to 99.9 percent of the quality baseline oil with the remaining portion being customization additives. A desired property of the motor oil, for example, wear protection, fuel economy and the like could be varied by focusing on the desired percent change of the property desired, which might perhaps be 20%, or by changing the concentration of the oil additive to obtain such property.

### CROSS-REFERENCE TO RELATED APPLICATION

This application is based on, and claims domestic priority benefits under 35 USC §119(e) from, U.S. Provisional Application Ser. No. 60/196,294 filed Apr. 12, 2000, the entire content of which is expressly incorporated by reference herein.

### BACKGROUND AND SUMMARY OF THE INVENTION

There are many times when consumers, whether they be fleet owners, garage owners, or individual drivers, are interested in having motor oils that are specifically suited for their particular requirements. It would be highly desirable if those individuals had a mechanism by which they could participate in the design of their motor oils, and particularly if they had ready access to the purchase of such oils over a wide area computer network (such as the Internet).

According to the present invention an interactive global computer network site is provided which allows a customer, in one of several ways, to participate in the design, selection or customization of a particular motor oil to fit that customer's need. In addition, the site may be used to directly order conventional products in addition to a wide variety of consumer products, which may be related to the operation of one's vehicle. These may include products related to the maintenance, driving or daily utilization of the vehicle. With respect to customization of the engine oil, the customer may choose between standard customization schemes recommended by the web site owner, customization schemes recommended by the web site owner based either upon information provided by the customer or customization schemes developed by the customer's preferences. In one instance, the motor oil may be customized by the motor oil manufacturer using customer defined characteristics. In another instance, the customer may assemble an oil based upon component recommendations by the motor oil manufacturer. In yet another instance, the customer may actually design an oil which is optimized for the customer's needs or preferences based upon preferred or defined component recommendations using formulation guidelines and computer models provided by the motor oil manufacturer and made available in real time over the global computer network web site. The models would limit the extremes of formulating flexibility in order to maintain credentials, or, alternatively, give a warning that such credentials could not be supported outside a given range.

Having designed or having recommended the motor oil, the customer could decide whether it should be delivered to a dealer, a garage, a quick lube station, a residence, or elsewhere. A flexible blending facility may be utilized to make and package the oil and the flexible blending facility might, then, dispatch the oil to the desired shipping location. Customization might include use of the customer's name or graphics on the package designed for the oil. Alternatively or in addition a mobile oil change business or franchise could install, and possibly even blend, the custom oil at the customer's house, place of work, garage, or other location.

The key, guide, or profile, to a motor oil's or lubricant's performance is reflected in the test credentials that it carries. These are established by referencing an oil's performance using industry standard tests. It is these performance credentials that are used to guide the customer in matching the recommended oils to their applications and also to support warranty claims or the like. If custom enhancements are introduced as additional features on top of baseline industry standard performance, then engine protection and performance would most likely be above an industry accepted level or standard. These enhancements may be introduced, for example, by modifying the composition of the motor oil's performance additives or by adjusting the base stock composition of the motor oil by applying accepted industry standard practices as outlined in the codes introduced by industry organizations such as the American Chemistry Council (ACC) and Technical Committee of Petroleum Additive Manufacturers in Europe (ATC). These modifications permit the customer, if desired, to introduce one or more product enhancements from a list, such as that below, which outlines several of the potential product enhancements and the corresponding compositional modifications which may be required to implement the enhancements.

TABLE 1

| | ILLUSTRATIVE |
|---|---|
| | COMPOSITIONAL |
| PRODUCT ENHANCEMENT | MODIFICATION |
| New oil viscosity | Base oil, Viscosity modifier |
| Fuel economy | Product viscosity, Additives |
| Low temperature performance: | Viscosity, Pour point depressant, |
| Cranking, Startability, Pour point | Base oil |
| OEM credentials: Oxidation | Additive concentration and choice |
| protection, Wear protection, | |
| Deposit control; Engine cleanliness, | |
| Corrosion protection, etc. | |
| Response to climatic extremes | Base oil |
| Volatility | Base oil |
| Extended drain intervals | Additive concentration and choice, |
| | Base oil choice |
| Soot handling | Additive concentration and choice |
| Other customization features | Appropriate compositional adjust- |
| | ments |

The chosen enhancements could be communicated directly to the manufacturing facility where the appropriate oil could be made and shipped.

The customer might have little or no knowledge of the science and techniques of formulating motor oils, but still desire to create an oil that meets their particular needs.

They would thus need access to on-line formulating guidance as an integral part of the design process. Such guidance, especially provided by an interface to an expert system, could take the form of graphical representations of statistically-derived performance maps, which would be more intuitive and clearer than simple numeric models. The performance enhancements offered would need to be comprehensively tested in order to:

Generate and then provide performance maps in the first place.

Establish support within industry guidelines or to provide technology background upon which to base engineering judgment for adjusting component composition.

Develop product substantiation for customization profile.

Provide data in order to support the product's fitness for use.

The guidance could also have a heuristic element giving relevant assistance as the design progresses.

Manufacturing custom motor oil could involve different manufacturing techniques than are used today. Individual performance additive components generally treat at about 6% wt or lower in the finished motor oil formulation. Oftentimes, in order to achieve optimized performance, it is necessary to use more than one additive with a specific enhancement attribute because combinations of additives frequently behave in a complimentary or in a synergistic manner. Hence, when one or more supplemental additive components are added to the fully formulated motor oil to achieve extra or enhanced performance they will typically treat at levels below those commonly found in the finished oil, and most likely at concentrations of 1 % wt to 2% wt or less of the finished oil.

Introducing such low concentrations of highly concentrated performance additives into the baseline, finished motor would be difficult and may create serious mixing and compatibility problems. To overcome such potential issues, it may be necessary to introduce the boost components as dilute performance additive blends. Using dilute ingredients means that it would be easier to use a continuous in-line blending technique, which could help in the rapid preparation of small quantities of chosen oil.

Alternatively, where practical, stock blends of fully capable lubricants designed to meet specified higher performance level targets might be admixed to deliver a lubricant meeting the objective or objectives for the customized oil.

The global computer network enables this whole process. There are several areas that would not be viable without it:

Real-time gathering of customer input.

Real-time analysis of these data using expert systems/models to make recommendations.

On-line formulation guidance and design in real-time.

Communication of the design to the manufacturing facility.

Dispatch and delivery coordination transparent to customer.

Worldwide (or other large area) accessibility.

According to one aspect of the present invention there is provided: A method of obtaining motor vehicle engine oil having user desired credentials by employing communication capabilities available by a wide area computer network by: (a) Inputting data, including type information about driving habits, the driving environment and about the motor vehicle in which the engine oil is to be utilized, targeted and sufficient to identify a user3s requirements and customer desired options, (b) Analyzing the data by computer and (c) after having analyzed the data as in (b), utilizing the input information to provide a motor vehicle engine oil having the desired enhancements targeted to fulfill the customization requirements.

In the method as described above, preferably (a) is practiced to input a wide range of information including, but not limited to, environment of use, operational characteristics, type of vehicle and vehicle data and vehicle maintenance records all of which may be archived as the customer's historical record base. Some specific items that preferably (a) is practiced to input might include ambient temperature, average driving distance and type of driving. A customer's interest in fuel economy, cold weather starting, engine longevity and extended oil drain intervals may also be included. Preferably (b) is practiced to recommend an engine oil based upon at least one of environment of use, desired operational characteristics and the type of vehicle data. More preferably (b) is practiced to recommend an engine oil based upon at least two or more of environment of use, desired operational characteristics and the type of vehicle data. Typically (a)-(c) are practiced to design, produce, and deliver or make available, a customized engine oil.

In the preferred embodiment (a) is practiced by electronically displaying a questionnaire on a computer screen connected to a wide area (e.g. global) computer network, and prompting a user to input information into the questionnaire. Desirably (c) is practiced by providing a quality baseline oil which may be supplemented or modified in the final customized motor oil. Oftentimes, customization will impart improvements in attributes, a partial list of which appears in FIG. 1, namely, dispersancy, detergency, oil stability, wear control, corrosion protection, oxidation control or anti-oxidancy and fuel economy.

The finished customized motor oil may contain from about 5 percent to 99.9 percent of the quality baseline oil with the remaining portion being customization additives such as fuel economy additives or anti-wear additives. More often the finished customized motor oil will contain from about 50 percent to 99.9 percent of the quality baseline oil with the remaining portion being customization additives. More often, again, the finished customized motor oil will contain from about 60 percent to 99.9 percent of the quality baseline oil with the 30 remaining portion being customization additives. Again, often, the finished customized motor oil will contain from about 75 percent to 99.9 percent of the quality baseline oil with the remaining portion being customization additives. Most often the finished customized motor oil will contain from about 80 percent to 99.9 percent of the quality baseline oil with the remaining portion being customization additives.

To practice (c) the customer will choose the customization feature or features most desired from among those provided in a list of customization features or attributes. The customer will then choose from the prepared listing of attributes either a percent enhancement in attribute quality or a percent increase in concentration of additive associated with the attribute. For example, if the customer wishes to change the fuel economy ascribed to the motor oil, the customer may choose to change the fuel economy additive by a fixed amount (i.e., change in concentration percentage of the additive) or may wish to target a percentage relative change in fuel economy. Alternatively, to practice (c) the customer will choose two or more, and sometimes three or more, customization features most desired from among those provided in a list of customization features. The customer will then choose from the list of attributes, either a percent enhancement in each attribute quality desired or a percent increase in concentration of each of the additives associated with the attribute.

For example, if the customer wishes to change the fuel economy ascribed to the motor oil and the level of wear protection or antiwear attribute of the oil, the customer may choose to change the fuel economy additive by a certain fixed amount (i.e., change in concentration percentage of the additive) and the antiwear additive by, perhaps a different fixed amount (i.e., change in concentration percentage of the additive) or the customer may wish to target a percentage relative change in fuel economy and, perhaps target a different percentage relative change in wear protection. Illustratively, (c) may be practiced to provide from about 0. 1 % to about 100% or more change (most often this change is an increase) in the fuel economy attribute or, alternatively, to provide from about 0.1% to about 100% or more change (most often this change is an increase) in wear protection or, alternatively, to provide in the same customized motor oil both from about 0.1% to about 100% or more change in fuel economy attribute and also from about 0.1% to about 100% or more change in wear protection.

Most preferably (c) is practiced to provide change (most often this change is an increase) in absolute percentage of additive treat rate. Illustratively, (c) may be practiced to customize fuel economy performance by providing an absolute change of from about 0.01% fuel economy additive (friction modifier) to about 10% or more fuel economy additive. Alternatively, (c) may be practiced to customize wear protection performance by providing an absolute change of from about 0.01% anti-wear additive to about 10% or more anti-wear additive or, alternatively, to provide in the same customized motor oil, both, an absolute change of from about 0.01% fuel economy additive (friction modifier) to about 10% or more fuel economy additive in addition to an absolute change of from about 0.01 % anti-wear additive to about 10% or more anti-wear additive. The change in additive concentrations may be introduced by using appropriate blend concentrates in place of the 10 neat additive compositions.

Also, (c) may be practiced to change both detergent and dispersant concentration levels over the range from about −50% to about +200% for each component compared to their concentration levels in the quality baseline motor oil for the same vehicle. Alternatively, (c) may be practiced to change either (or both) the detergent or the dispersant attribute individually over the range from about −50% to about +200% compared to its concentration level in the quality baseline motor oil. In general, (c) may be practiced to add one or two or more enhanced attributes such as, but not limited to, enhanced low temperature startability, enhanced high temperature viscosity, extended drain capability, enhanced wear protection, enhanced corrosion protection, enhanced fuel economy, enhanced oxidation protection, enhanced detergency, and enhanced dispersancy.

The method also preferably comprises displaying on the computer screen indicia indicating the ability of the user to order other automotive products.

According to another aspect of the present invention there is provided a method of obtaining custom engine oil by: (a) Using an implement to transmit information about a user's motor vehicle type, environment of use, and desired operational characteristics, to a customized blending facility; (b) Blending a custom engine oil using the information from (a); and (c) delivering to, or making available for pickup by the user from (a) the custom engine oil from (b). For example, (a) may be practiced using a telephone, a computer network (such as a global computer network), or prepared document.

The invention also relates to a custom engine oil made by practicing any of the methods set forth above, and to methods, equipment and systems such as shown and described to achieve desired results.

One exemplary embodiment according to the present invention may be seen with respect to the accompanying drawings.

### BRIEF DESCRIPTION OF THE DRAWINGS

FIG. 1 is a schematic which illustrates some of the many options available to the customer for inputting the custom motor oil request and other associated information (the figure also presents the options, in terms of facility, which are available for blending, and delivery of the motor oil and ultimately for completing or fulfilling the oil change);

FIG. 2 is a schematic representation of a document which, when completed, provides the motor oil manufacturer with information to assist the customer in the maintenance and the utilization of the vehicle;

FIG. 3 is a schematic representation of a questionnaire designed to provide the motor oil marketer and the customer with key information concerning the specific criteria for customization of the motor oil;

FIG. 4 is a flow chart in relation to a terminal showing an initial web site screen to allow a customer to choose a non-minimally or customized product or one of three customization options;

FIGS. 5a through 13 are consecutive web site screens in which a motor oil user is either assisted in choosing an appropriate motor oil or is assisted, to different degrees or levels, in the interactive design of a customized motor oil, with FIGS. 9 through 11 being exemplary correlation charts that may be utilized pursuant to the invention, to assist in blending and targeting the cost implications of the performance enhancements;

FIG. 14 is a high level flow chart indicating the various interactions between the customer and other aspects of the process for allowing the customer to order motor oil, either conventional or customized product over a global computer network;

FIG. 15 is a simplified example of a possible mixing scheme; and

FIG. 16 is a web site screen whereby the engine oil marketer may offer car care products and other products that may be associated with the driving experience.

### DETAILED DESCRIPTION OF THE INVENTION

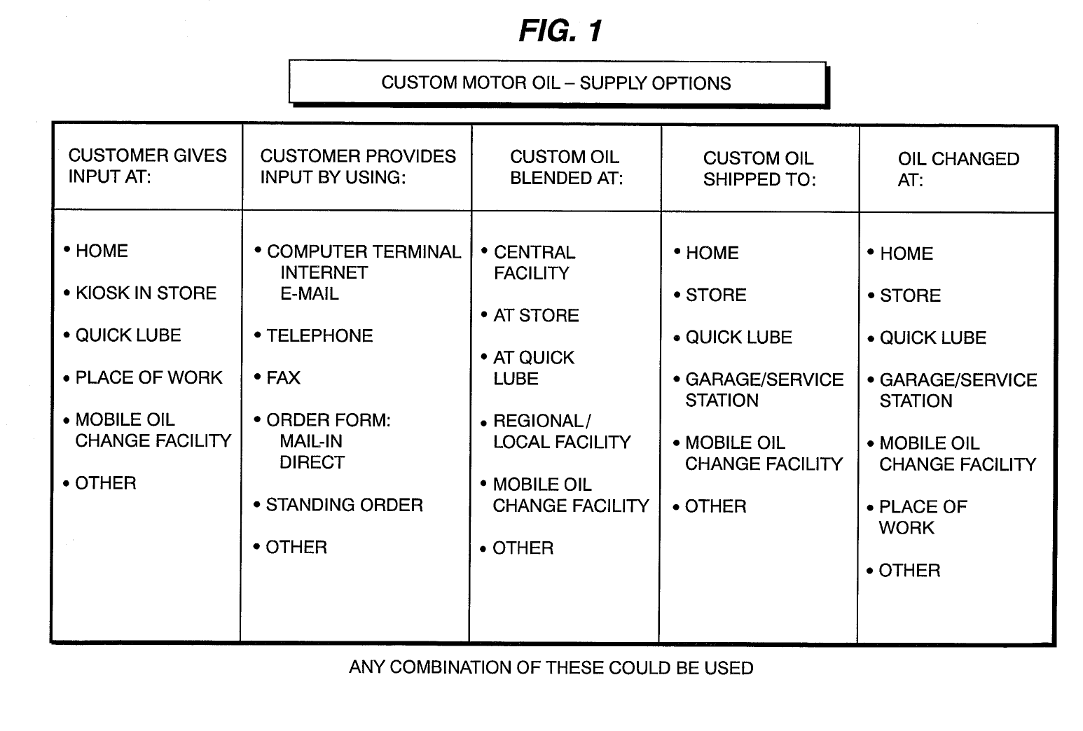

FIG. 1 illustrates that the user may input data from home, a kiosk, rapid lubrication facility such as Quick Lube, work, mobile oil change facility or other facilities which may be available.

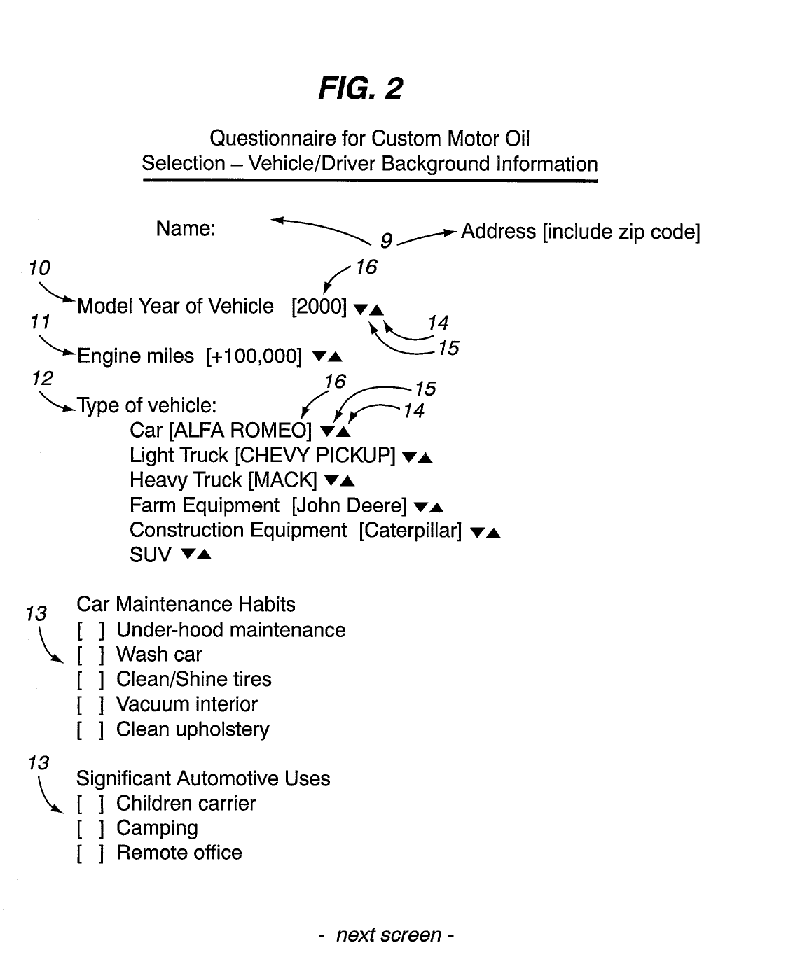

The questionnaire of FIG. 2 preferably requires the customer to input all relevant information such as user name and address (including zip code) information 9, the model year of the vehicle 10, engine prior use 11 and/or type of vehicle 12. The user may simply click on (using a mouse or any other conventional implement for selecting items on a computer screen) the appropriate boxes 13 in the various categories. For each of the components of the elements 10 through 12 conventional up and down arrows 14, 15, respectively, may be used to display predetermined information in the box at issue, such as the box 16. When the arrows 14, 15 are used for the box 16 relating to vehicle type, such as car type, once a particular manufacturer's name is displayed the user clicks on it and then various model numbers or names for that manufacturer's vehicles will also be displayed, for example in the same manner that printers may be selected from pre-existing menus in conventional personal computer software operating systems.

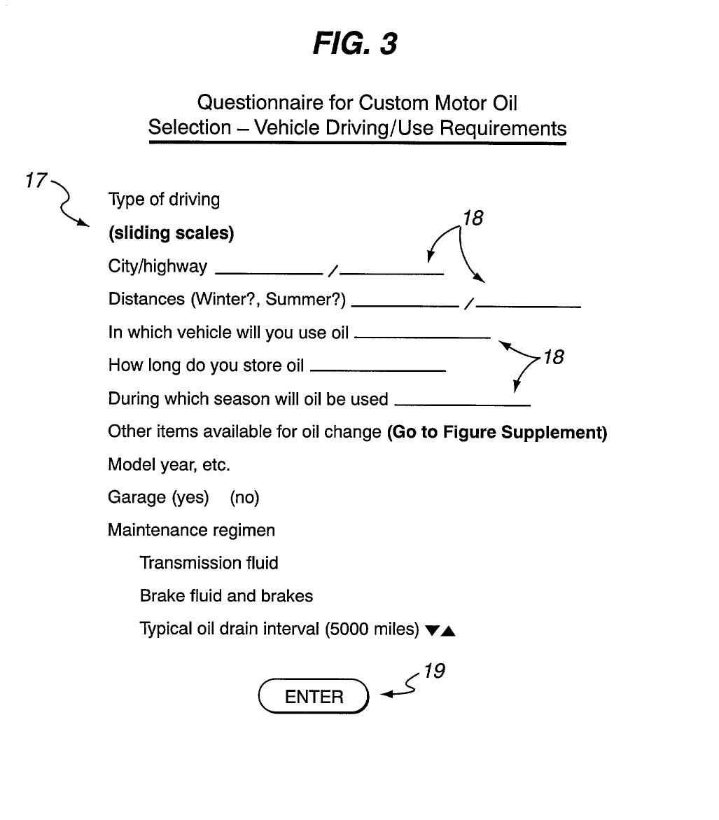

A screen dedicated to a questionnaire for vehicle driving/use may also be provided as shown in FIG. 3. In this regard, the driving/use requirements questionnaire of section 17, may include any suitable requirements relating to a user's normal driving maintenance style or the like may be provided. Only a few examples are given in FIG. 3, it being understood that many other requirements or criteria (such as how often the user normally changes the motor oil in his or her vehicle, etc.), and many other options within any particular category, may be provided. Furthermore, the input of data on the screens of FIGS. 2 and 3 may be by any suitable conventional technique.

Once the user fills in the appropriate boxes 13 of FIG. 2, or enters data in other conventional ways in the areas 18 of FIG. 3, the user may click on the “Enter” icon 19 so as to transmit the relevant information to a facility or computer where the information is used to determine what oil to recommend to the customer.

The information can be gathered and evaluated manually by an expert in the art who will determine what additives are available, what base engine oil would be best for the additives, and the like, considering the selections made in each of the areas 10 through 18, or a computer program can be utilized for automatically selecting the appropriate motor oil.

If the questionnaires of FIGS. 2 and 3 are utilized, then there will typically be conventional shopping cart, payment, and shipping address screens that are common conventionally for Internet web sites that allow the purchase of standard or customized products (such as www.curiosities.com, or such as shown in U.S. Pat. Nos. 5,727,163, 5,960,411, and the prior art referenced therein, the disclosures of which are hereby incorporated by reference herein).

As an alternative to the “Recommendation” format that is provided utilizing the questionnaire of FIGS. 2 and 3, the web site may actually provide an interactive site that facilitates design of the motor oil by the customer, or at least the perception of that design. For this purpose the exemplary screens of FIGS. 6 through 8 are illustrated, it being understood that these are exemplary only and various other features may be provided.

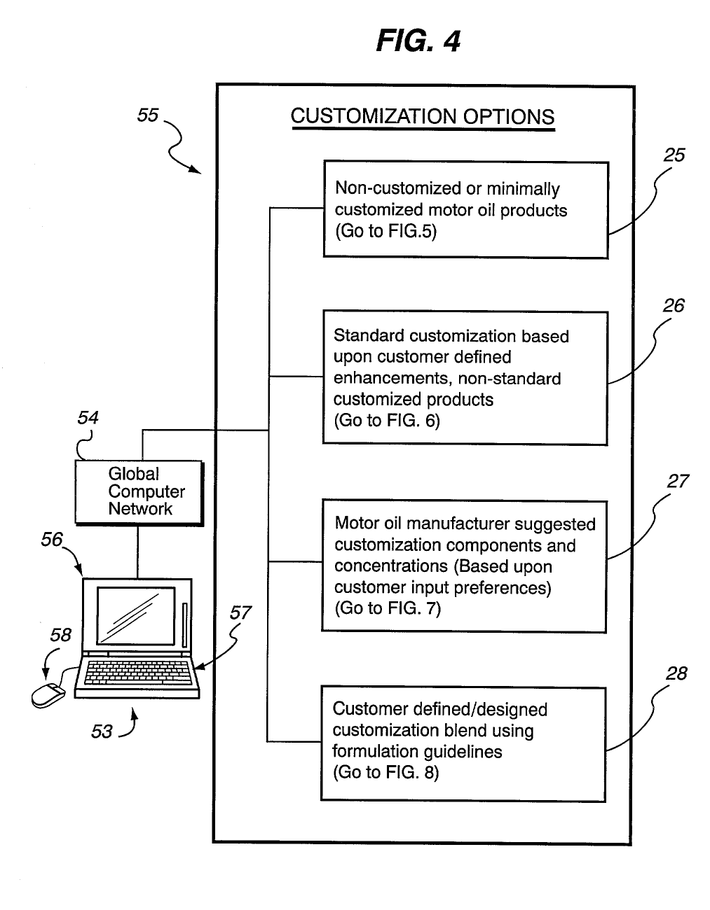

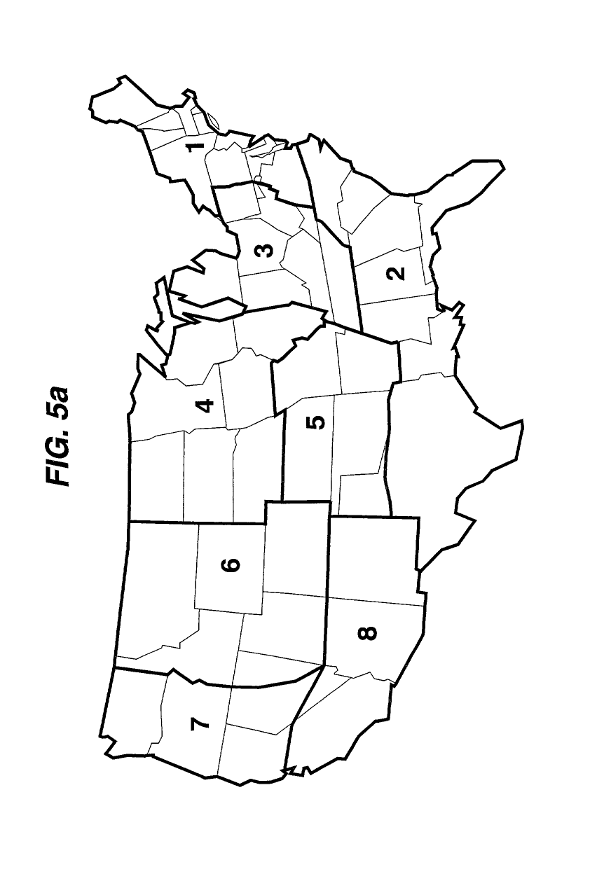

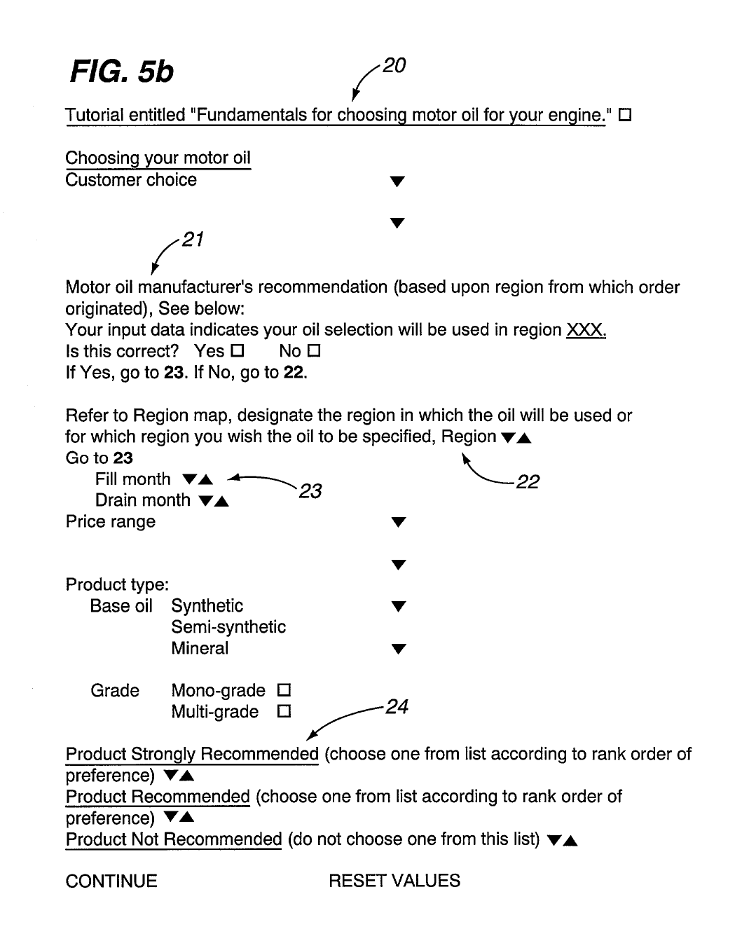

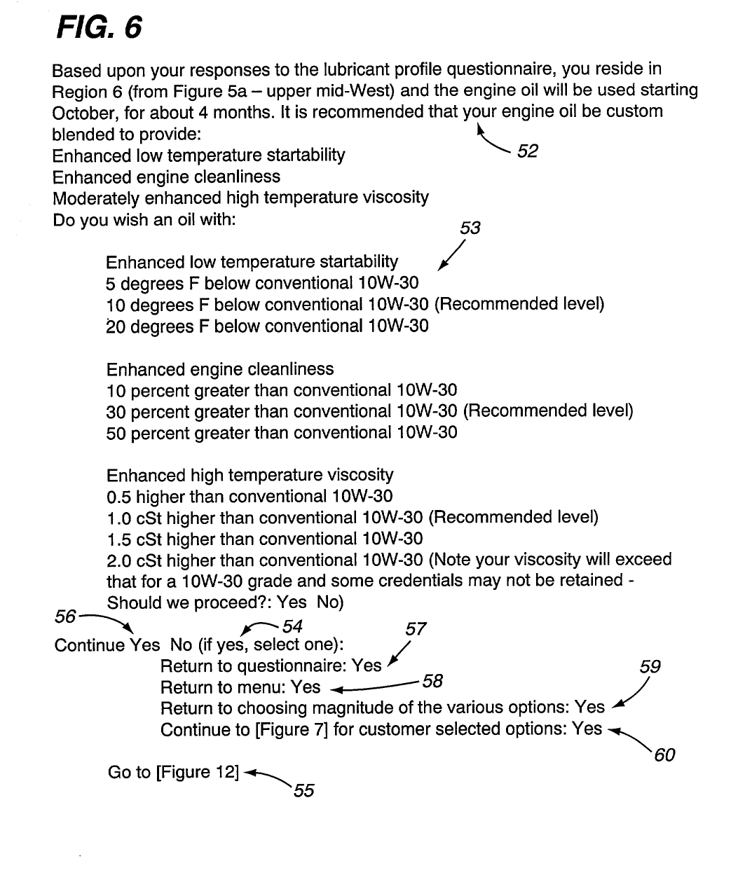

FIG. 4 is a flow chart which directs the customer to choose either non-,or minimally, customized product or one of three customization options. The customer will be directed to a web site screen illustrated in FIGS. 5a and 5b if the choice is a product which is not performance customized or only minimally customized. It should be noted that an illustration of minimally customized motor oil product is motor oil which has been recommended based upon customer input information regarding region of the country, season and driving habits. If, on the other hand, the choice is for any of the customization options, the customer will be directed to web site screens appropriate for the customer's choice. In these latter cases, the customer is offered the options of choosing between menu selected options based upon information provided, as per FIGS. 2 and 3, or based upon specific customer preferences. The customer will be directed to choose from a menu of desired performance profile attributes or enhancements as well as customer created inputs which will guide the customization of the product.

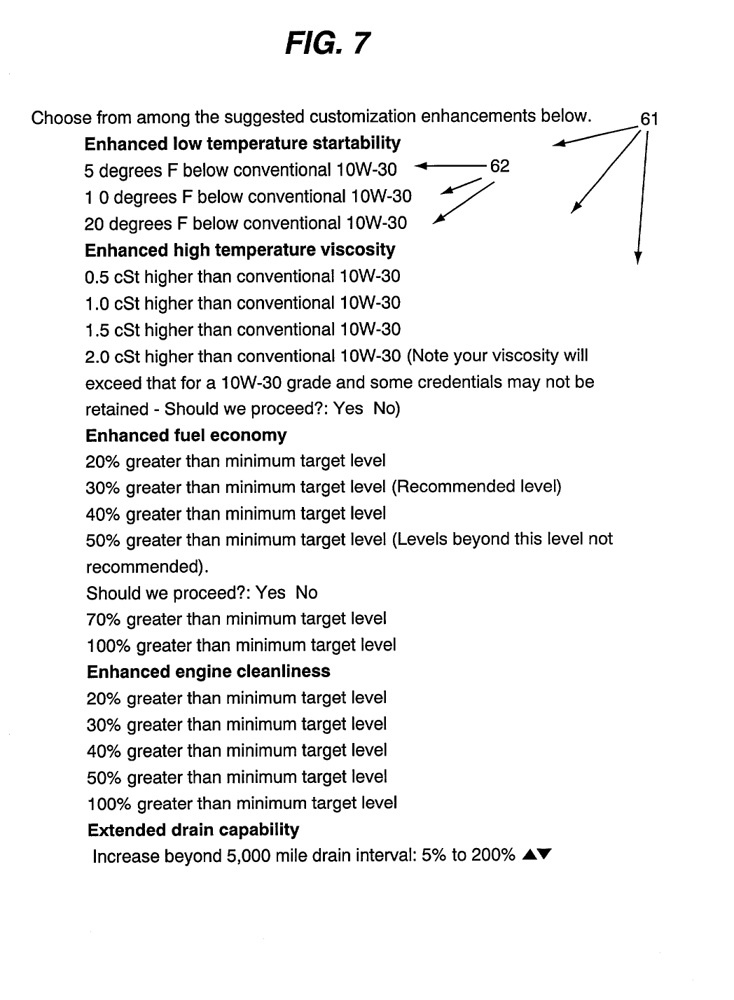

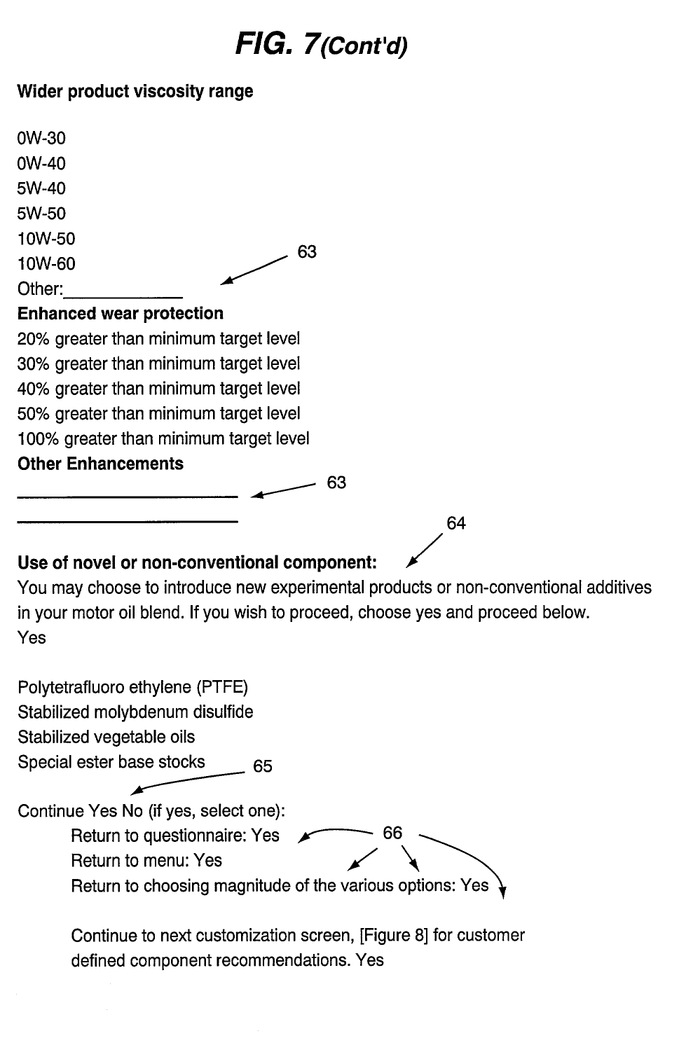

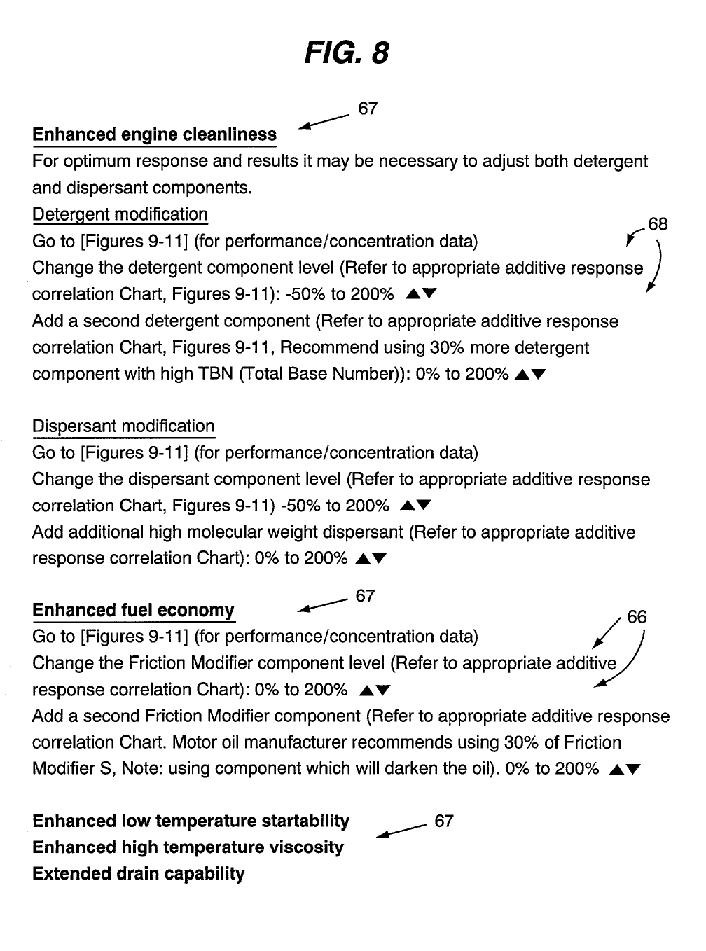

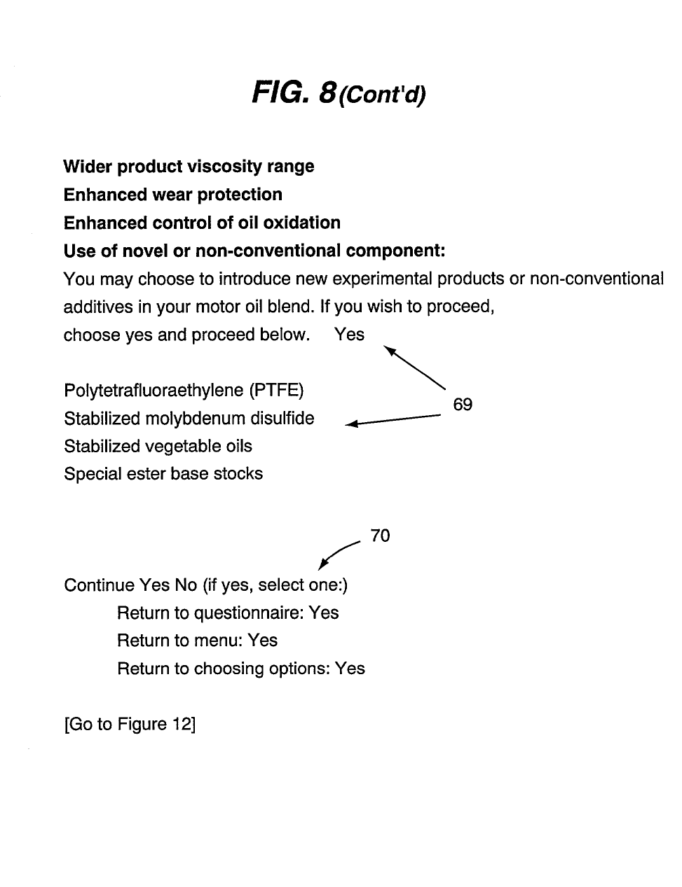

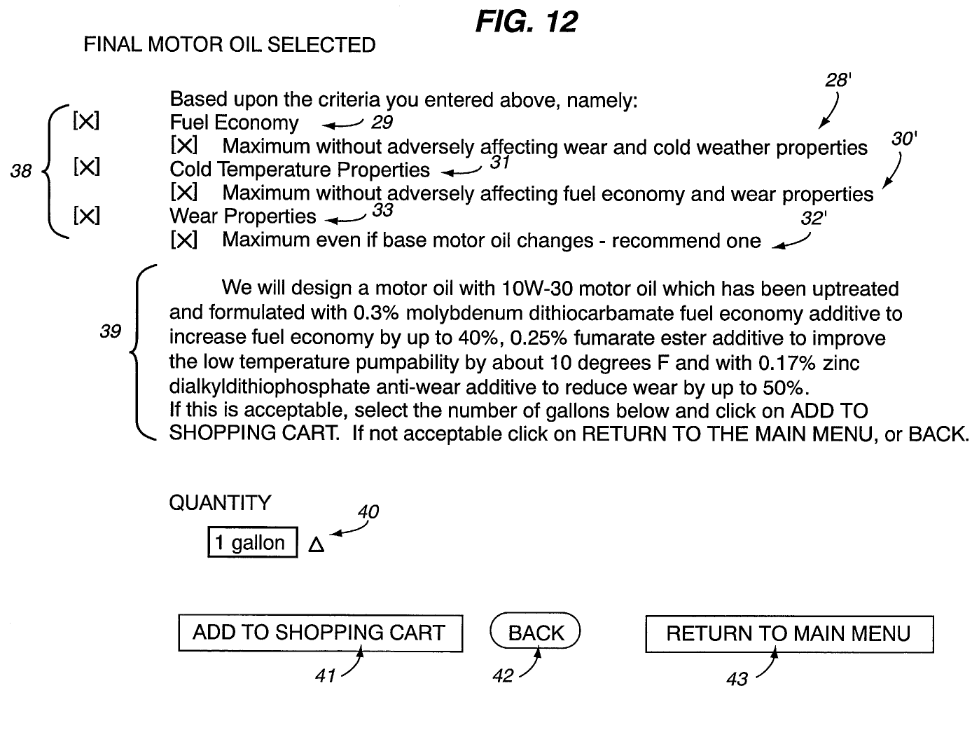

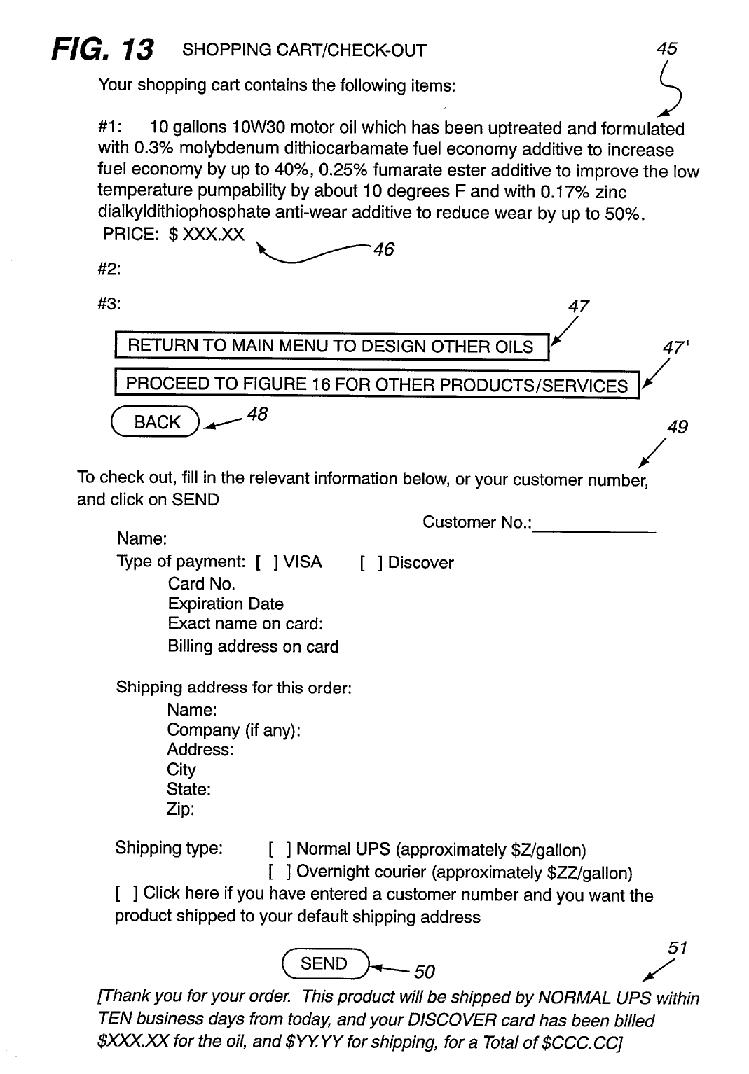

If the customer wishes to have the motor oil customized by the motor oil manufacturer using customer defined characteristics, a web site screen illustrated in FIG. 6 may be provided. If the customer wishes to design a custom product based upon component recommendations by the motor oil manufacturer, a web site screen illustrated in FIG. 7 may be provided. If the customer wishes to design a custom product based upon customer defined component recommendations using formulation guidelines provided by the motor oil manufacturer, a web site screen illustrated in FIG. 8 may be provided. FIG. 12 is a web site screen in which the customer reviews the product purchased. FIG. 13 reviews the shopping cart and check-out. More specifically, FIG. 4 schematically illustrates at 55 the options that may be displayed on the user's monitor 56 whereby the user is requested to choose from a menu of four options 25-28 of motor oil type, either conventional or customized. After the user clicks on the web site, the user is directed to the corresponding screens, FIGS. 5a through 8. Selections may be made using a terminal 53 connected to a wide area (e.g. global) computer network 54 through a modem, DSL, cable, etc. to a source site where a computer 55 includes the software and data bases and processing capability to supply various screens for viewing on the monitor 56 of the terminal 53. The terminal 53 may be personal computer, hand held communication device allowing user input, dumb terminal, or other conventional structure capable of communicating over the network 54. Entries are made using the keyboard 57, mouse 58, push buttons (not shown), or other conventional input device, associated with the terminal 53. The terminal 53 may be located anywhere, e.g. a home, office, mall, kiosk, auto repair facility, etc.

FIGS. 5a and 5b illustrate non-customized or minimally customized oil that may be selected and/or recommended, the screen of FIGS. 5a and 5b being accessed by selecting 25 in FIG. 4. The customer may choose from a selection of products available at the retail marketer and shop on-line because of the convenience which it affords to the shopper. As an alternative the customer may choose to be guided in the selection process. To assist the customer, the market area is divided into regions which encompass environs exhibiting similar, but not necessarily identical, performance requirements. One possible exemplary market area covering the United States of America is shown in FIG. 5a. The customer might begin by clicking on an icon to access a tutorial on the fundamentals for choosing motor oils as shown at 20 and then moving to the selection of a motor oil as shown at 21. Alternatively the customer may choose the option shown at 21, straight-off. The recommendation may be provided based upon region or zip code, the latter inserted at 9 in the questionnaire (FIG. 2), in addition to others, such as grade, product type and customer price target. The customer may then confirm the chosen region at 22 and the season of intended use at 23. After choosing the customer preferences, the initial recommendation is highlighted as shown in 24. The user may select the second (or subsequent) recommendation by scrolling down the list of strongly recommended or recommended motor oil choices and clicking on the desired choice. The screen also preferably includes a list of products which may or may not be appropriate for the particular region and/or season for which the product is requested.

FIG. 6 illustrates the supply of “custom”motor oil by a manufacturer based upon customer defined characteristics, by selecting 26 in FIG. 4. In FIG. 6, the customer is provided with a customized oil recommendation based upon the information provided in FIGS. 2 and 3. The screen will present the customization options which the engine oil marketer recommends as shown at 52. The customer may choose the recommended magnitude of performance enhancement or may choose a slightly different level offered as options at 53. If the customer is satisfied with the engine oil, the customer will choose not to continue, 54 and move to FIG. 12 via 55. The customer may choose to continue via 56. This offers the customer several options including: modify the questionnaire, 57, return to the main menu, 58, return to selection of performance magnitudes, 59 or choose to select from an expanded list of options, 60. By choosing this last option, 60, the customer will be proceed to FIG. 7.

FIG. 7 illustrates component recommendations from a motor oil manufacturer by selecting 27 in FIG. 4. In FIG. 7 is illustrated the customization option in which the motor oil manufacturer provides the customer with a menu of engine oil component customization options which will be introduced into the motor oil and then provides an engine oil fulfilling the customization enhancements which were identified by the customer. In fulfilling the product request, the motor oil marketer's expert system will utilize component recommendations from an internal data base. In FIG. 7 is an illustration of a screen in which the customer is offered a wide range of menu selected options, at 61. The customer will be prompted to choose from among several performance levels for the various options chosen, 62. In addition the customer may enter options which are not menu selected illustrated by 63 or from among novel and/or non-conventional componentry, 64. Once the performance options and their performance levels are chosen, the motor oil manufacturer will blend the appropriate oil and prompt the customer to proceed to FIG. 12 by selecting 65. Alternatively, the customer may either return to the main menu, or return to selection of performance magnitudes, or choose to proceed to the next customization level in which the components and their concentrations are customer chosen, as indicated by option 66. By choosing this last option 66, the customer will be proceed to FIG. 8.

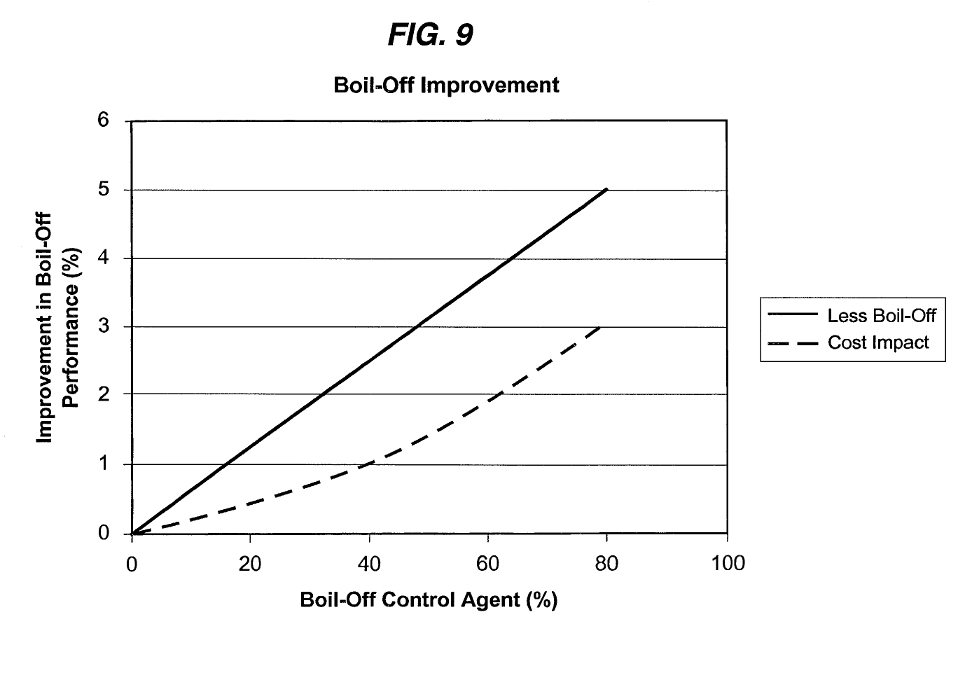

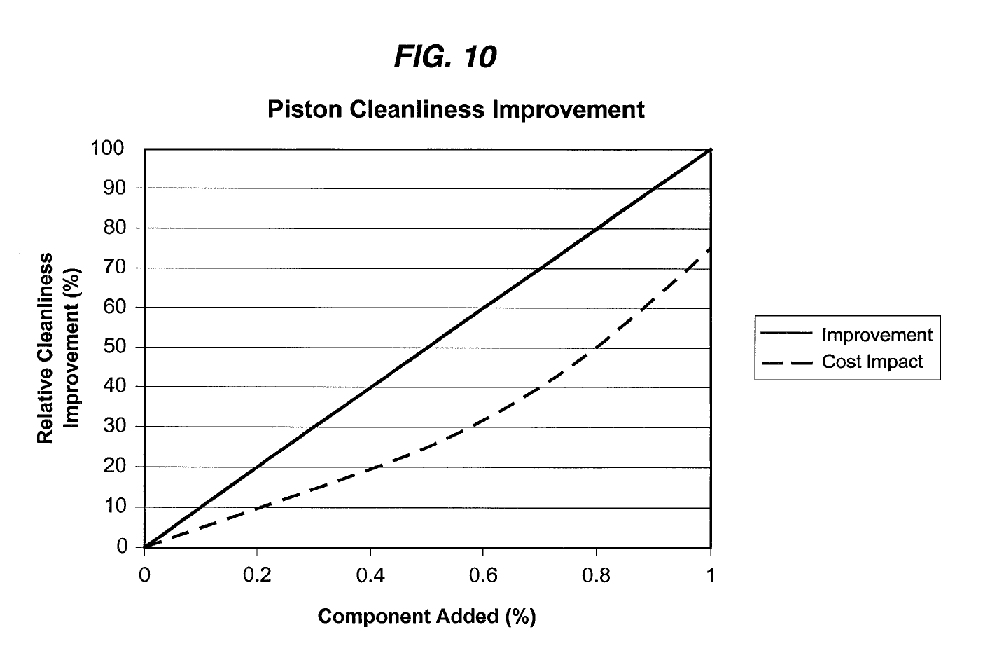

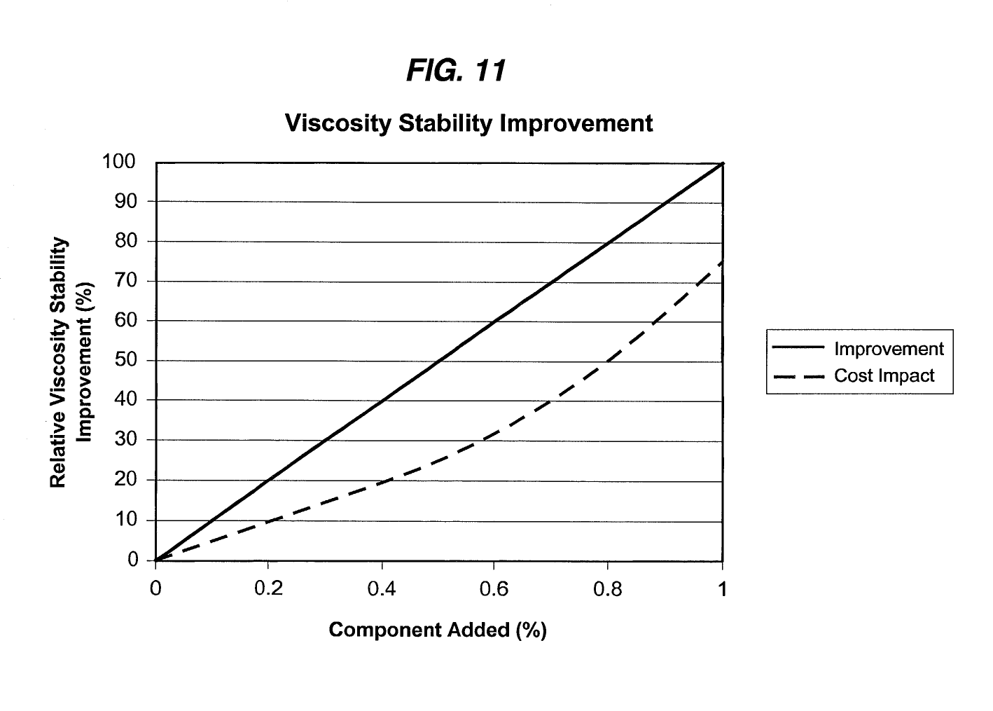

FIG. 8 illustrates customer-defined component recommendations, by selecting 28 in FIG. 4. More specifically, FIG. 8 illustrates the screen for the customization option in which the customer not only chooses the customization options, but also selects the components and their concentrations. These selections are facilitated by the motor oil marketer who provides component performance responses and blend recommendations. The customer is provided with a menu of customization options, 67. This menu includes component response data and strategies, 68, for applying the component data in the manufacture of engine oils. The data may be supplied as correlation tables, charts, graphs etc. Illustrative correlation charts are presented in FIGS. 9 through 11. FIGS. 9 through 11 illustrate screens that display correlation charts which the customer might employ to generate motor oil formulations meeting enhanced performance targets. The customer will choose an appropriate concentration of additive component corresponding to the desired level of change in performance parameter. In addition, data may be included in the charts which will permit the customer to assess the incremental cost impacts of the composition changes being contemplated. Alternatively, the charts illustrated in FIGS. 9 through 11 will permit the customer to determine how best to achieve a cost effective motor oil which fulfills the customer's objective.

Information provided in FIG. 8 may also provide guidance if the customer wishes to use more than one component. If more than one customization enhancement is desired, the complete implementation of all of the performance enhancements will, most likely, require the use of two or more additive components. Options for the use of novel or non-conventional materials, 69, are also available as well as close-out options, 70, like those in FIGS. 6 and 7.

FIG. 12 illustrates another screen that will be displayed to the user after selection of the appropriate requirements from one of FIGS. 5a-8 the details of the screen of FIG. 12 being dependent upon the selection in one (or more) of the screens of FIGS. 6-8. FIG. 12 illustrates the display of the particular requirement 28′ associated with the Fuel Economy enhancement 29, and, similarly, the particular requirements 30′ and 32′ associated with the Cold Temperature property-enhancement 31 and the Wear property enhancement 33. Then, below this, repeat of the customer's selections, collectively provided in the area 38 in FIG. 12, as a statement 39 from the site operator as to what oil has been selected. The level of description provided for the listing 39 in FIG. 12 is only one of many examples. In this example a high level of detail is provided including the base oil selected, and the approximate percentages of particular additives that will be provided. The listing 39 also provides instructions on what to do further, including selecting the appropriate quantity using the icon and arrows 40, and, once the appropriate quantity is selected, clicking on the “Add to Shopping Cart” icon 41. Of course the “Back” icon 42 or “Return to Main Menu” icon 43 may alternatively be selected.

If the “Add to Shopping Cart” icon 41 is clicked on from the screen of FIG. 12, then a screen like that of FIG. 13 appears on the user's computer monitor. As is conventional for Internet ordering systems, the screen of FIG. 13 will list the items in the shopping cart, such as the item 45 (from the listing 39 of FIG. 12), will include the price 46, will provide icons 47 and 47' to allow the user to select other products, or will include an icon 48 to allow the user to return to the screen of FIG. 12, and will include various ordering information. The ordering information provided from line 49 downwardly in FIG. 13 can be of any suitable type, and is per se conventional, allowing the user to select the type of payment, the shipping address, the manner of shipping, etc., including allowing utilization of the customer number or other data that calls up from the memory of the computer at the web site operator's location, information about the customer, so it need not be repeated on the screen of FIG. 13. Ultimately if the user clicks on the “Send” icon 50 the appropriate order will be placed, and typically a message —— such as the message 51—— will then be displayed on the screen indicating that the order information has been received and giving the terms of shipment, and perhaps also displaying a confirmation number for future use by the customer in tracking his or her order.

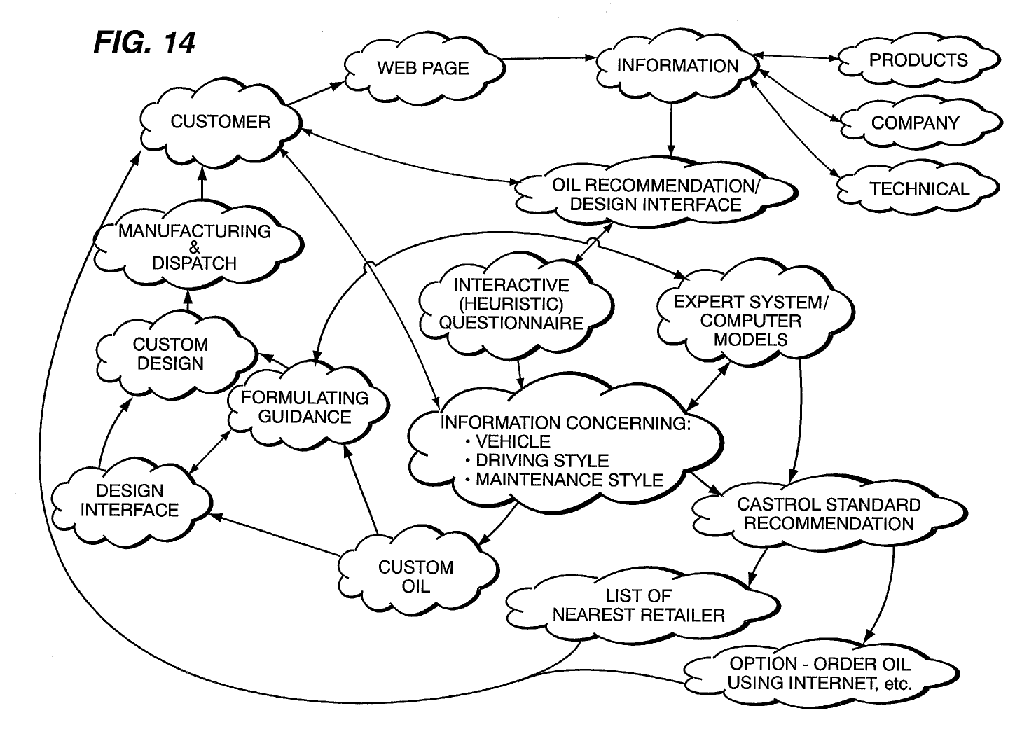

FIG. 14 is a high level schematic indicating the inter-relationship between various components that will be utilized to implement the practice of the invention, such as utilizing the screens and formats of FIGS. 1 through 13.

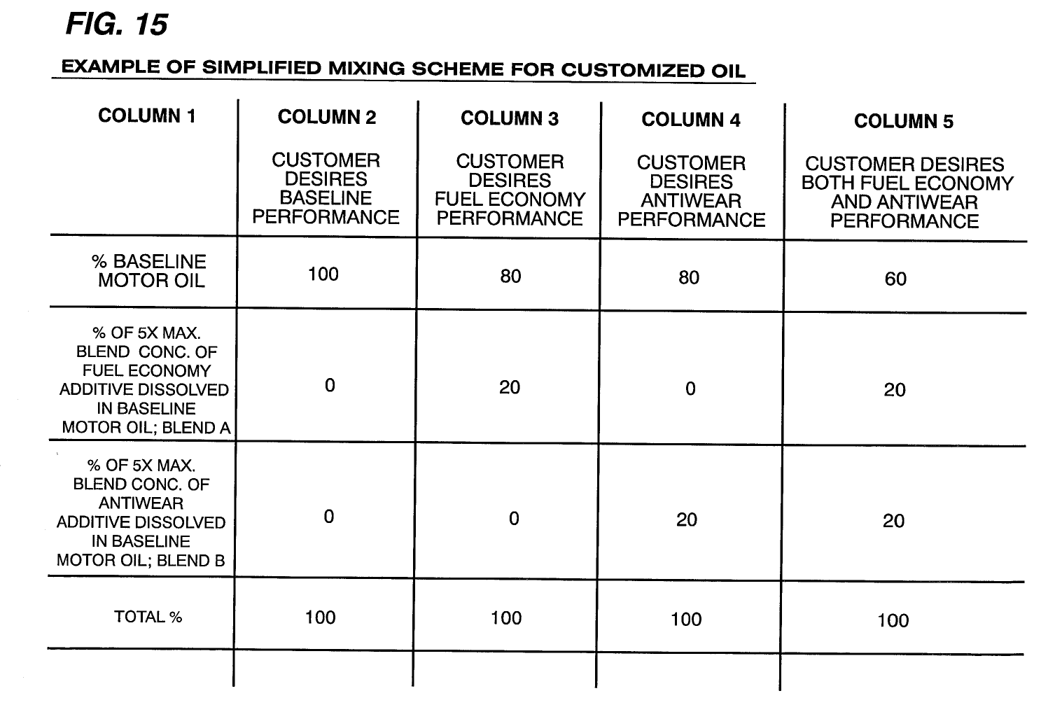

FIG. 15 is a simplified blending scheme which might be employed in preparing customized motor oils. The marketer would begin with a quality baseline motor oil blend comprised of the desired base stock and additive formulary needed to meet the level of performance typical for the region wherein it will be used, etc., as described in FIGS. 5a and 5b. This typical product will be supplied if the customer does not wish to include additional customized features, as illustrated in FIG. 15, column 2.

If the customer wishes to customize the blend with performance attributes beyond those offered in the quality baseline product, additional formulated blends might be commingled with the baseline blend. For example, if the customer wishes to double the concentration of friction modifier, a formulated blend comprised of the baseline level of desired base stock and additive formulary and a five-fold increase in friction modifier would be blended, Blend A. This enhanced fuel economy blend would be used at a ratio of one part enhanced fuel economy blend to four parts of the baseline blend in order to generate a finished product fulfilling the customer's product request. This is illustrated in FIG. 15, column 3. A request for a two-fold increase in antiwear additive would be fulfilled in a similar manner using Blend B. This is illustrated in FIG. 15, column 4.

A request to increase the response of two attributes, for example, fuel economy and antiwear, is, also, illustrated in FIG. 15, column 5. In this case, the enhanced blend composition might be formulated by increasing the concentration of both of these additives, each being used at the same increased concentrations as illustrated above. The enhanced formulation might be blended by co-mingling one part of Blend A with one part of Blend B and with three parts of the baseline blend. As illustrated in FIG. 15, column 5, this would generate a finished product having both of these additives at the same increased concentrations.

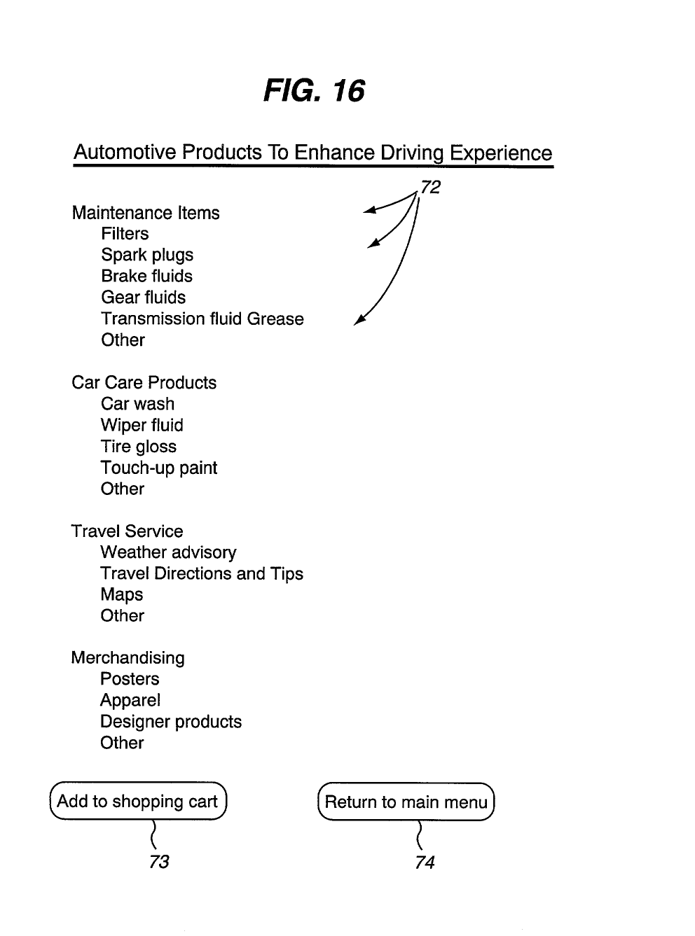

FIG. 16 is illustrative of a screen which the customer may select in order to access car care products and other products which may be associated with the driving experience. The items which might be purchased include ancillary fluids, such as brake fluid and grease, car care products, such as wax and car wash, car care brochures, and merchandise and equipment, such as jackets and duffel bags. General and specific information associated with the driving experience such as travel assistance may also be accessed. When the customer clicks on the item icon 72, a catalog is accessed describing the product. The customer may include the product in the purchase by clicking on the appropriate icon 73, or return to other menus (e.g. see 74).

It should be understood that the description with respect to the above figures is exemplary only, and that a wide variety of modifications may be made within the scope of the invention. In general the invention relates to a method and apparatus allowing customized production and selection, or design, production, and selection, of motor oils that suit a particular customer's need (as well as motor oils so produced), and preferably in a highly user friendly format, such as over a global computer network (such as the Internet). Since the invention has been and can be described only in exemplary form it is to be understood that it is to be accorded the broadest interpretation possible limited only by the prior art.

What is claimed is:

1. A method of obtaining motor vehicle engine oil having user desired credentials by using a wide area computer network by:
(a) obtaining and inputting data, including type information about the motor vehicle in which the engine oil is to be utilized sufficient to identify a user's requirements;
(b) analyzing the data by computer; and
(c) after (b) providing a motor vehicle engine oil having recommended, or user-desired enhancements.

2. A method as in claim 1, wherein (a) is practiced to input only information about at least one of the environment of use, desired operational characteristics and type of vehicle and (b) is practiced to recommend an engine oil based upon at least one of environmental and desired operational characteristics and the type of vehicle data.

3. A method as in claim 2, wherein (a) is practiced to input at least one of expected ambient temperatures, average driving distance, normal type of driving, and interest in fuel economy, cold weather starting, and engine longevity.

4. A method as in claim 1, wherein (a)-(c) are practiced to design, produce, and deliver or make available, a customized engine oil.

5. A method as in claim 4, wherein (a) is practiced by displaying a questionnaire on a computer screen connected to a wide area computer network, and prompting a user to input information into the questionnaire.

6. A method as in claim 1, wherein (a) is practiced by displaying a questionnaire on a computer screen connected to a global computer network, and prompting a user to input information into the questionnaire.

7. A method as in claim 6, further comprising displaying on the computer screen indicia indicating the ability of the user to order other automotive products.

8. A method as in claim 4, wherein (c) is further practiced to provide a baseline motor oil of from about 5 percent to 99.9 percent of the final customized motor oil, and at least one of a fuel economy additive, an antiwear additive, a detergent additive, a dispersant additive, a corrosion inhibitor, an antioxidant, a pour point depressant or a blend stability additive.

9. A method as in claim 8, wherein (c) is further practiced to provide a baseline motor oil of from about 50 percent to 99.9 percent of the final customized motor oil, and at least one of a fuel economy additive, an antiwear additive, a detergent additive, a dispersant additive, a corrosion inhibitor, an antioxidant, a pour point depressant or a blend stability additive.

10. A method as in claim 8, wherein (c) is further practiced to provide a baseline motor oil of from about 60 percent to 99.9 percent of the final customized motor oil, and at least one of a fuel economy additive, an antiwear additive, a detergent additive, a dispersant additive, a corrosion inhibitor, an antioxidant, a pour point depressant or a blend stability additive.

11. A method as in claim 8, wherein (c) is further practiced to provide a baseline motor oil of from about 75 percent to 99.9 percent of the final customized motor oil, and at least one of a fuel economy additive, an antiwear additive, a detergent additive, a dispersant additive, a corrosion inhibitor, an antioxidant, a pour point depressant or a blend stability additive.

12. A method as in claim 8, wherein (c) is further practiced to provide a baseline motor oil of from about 80 percent to 99.9 percent of the final customized motor oil, and at least one of a fuel economy additive, an antiwear additive, a detergent additive, a dispersant additive, a corrosion inhibitor, an antioxidant, a pour point depressant or a blend stability additive.

13. A method as recited in at least one of claims 8-12, wherein (c) is further practiced to provide about 0. 1-1 00% improvement in at least one of fuel economy, wear performance, detergent performance, dispersant performance, oxidation protection, corrosion protection, low temperature performance and blend stability.

14. A method as recited in at least one of claims 8-12, wherein (c) is further practiced to provide an absolute increase of from about 0.1-1 0% in at least one selected from the group consisting of fuel economy additives, antiwear additives, detergent additives, dispersant additives, oxidation control additives, corrosion inhibitors, pour point depressants and blend stability additives.

15. A method as in claim 4, wherein (c) is practiced to add additives leading to at least two or more enhanced features selected from enhanced wear protection, enhanced fuel economy, enhanced detergency, enhanced dispersancy, enhanced low temperature startability, enhanced high temperature viscosity, extended drain capability, enhanced wear protection, corrosion protection, enhanced control of oxidation and enhanced blend stability.

16. A method as in claim 15, wherein (c) is practiced to add additives leading to at least three or more of said enhanced features.

17. A method as in claim 15, wherein (c) is further practiced to provide an absolute increase in each of said two or more enhanced features of from about 0.01 -10%.

18. A method as in claim 16, wherein (c) is further practiced to provide an absolute increase in each of said three or more enhanced features of from about 0.01 -10%.

19. A method as in claim 15, wherein (c) is further practiced to provide an improvement in each of said two or more enhanced features of from about 0.1-100 %.

20. A method as in claim 16, wherein (c) is further practiced to provide an improvement in each of said three or more enhanced features of from about 0.1-100 %.

21. A method as in claim 4, wherein (c) is further practiced to change at least one of detergent and dispersant concentration levels over the range from about −50% to about +200% for each component compared to their concentration levels in a quality baseline motor oil.

22. The method of claim 21, wherein both of said detergent and dispersant concentration levels are changed.

23. A method of obtaining custom engine oil by: (a) using an implement to transmit information about a user's motor vehicle type, environment of use, and desired operational characteristics, to a customized blending facility; (b) blending a custom engine oil using the information from (a); and (c) delivering to, installing or making available for pickup by the user from (a) the custom engine oil from (b).

24. A method as in claim 23, wherein (a) is practiced using a telephone, computer network, or prepared document.

25. A method as in claim 24, wherein (a) is practiced using a global computer network.

26. A method as in claim 25, wherein (a) is practiced by electronically displaying a questionnaire on a computer screen connected to a global computer network, and prompting a user to input information into the questionnaire.

27. A method as in claim 23, wherein (b) is practiced to add additives leading to at least two or more enhanced features selected from enhanced wear protection, enhanced fuel economy, enhanced detergency, enhanced dispersancy, enhanced low temperature startability, enhanced high temperature viscosity, extended drain capability, enhanced wear protection, corrosion protection, enhanced control of oxidation and enhanced blend stability.

28. A method as in claim 27, wherein (b) is practiced to add additives leading to at least three or more of said enhanced features.

29. A method as in claim 23, wherein (c) is further practiced to provide a baseline motor oil of from about 50 percent to 99.9 percent of the final customized motor oil, and at least one of a fuel economy additive, an antiwear additive, a detergent additive, a dispersant additive, a corrosion inhibitor, an antioxidant, a pour point depressant or a blend stability additive.

30. A method as in claim 29, wherein (c) is further practiced to provide a baseline motor oil of from about 60 percent to 99.9 percent of the final customized motor oil.

31. A method as in claim 29, wherein (c) is further practiced to provide a baseline motor oil of from about 75 percent to 99.9 percent of the final customized motor oil.

32. A method as in claim 29, wherein (c) is further practiced to provide a baseline motor oil of from about 80 percent to 99.9 percent of the final customized motor oil.

33. A custom motor oil made by practicing the method of any one of claims 4 and 15-32.
